(19) United States
(12) Patent Application Publication
(10) Pub. No.: US 2006/0119579 A1
(43) Pub. Date: Jun. 8, 2006

(54) Structure of a mouse and pad assembly

(76) Inventor: Wei-Ting Wang, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/004,954

(22) Filed: Dec. 7, 2004

(51) Int. Cl. G09G 5/08

(52) U.S. Cl. 345/163

(57) ABSTRACT

A mouse and pad assembly includes a pad member; and a mouse member, which is arranged on top of and connected to the pad member in such a way as to be angularly and linearly displaceable relative to the pad member; the mouse member has several buttons on an upper side thereof, and it has a sensor device facing the pad member for sensing movement of the mouse member relative to the pad member.

### BACKGROUND OF THE INVENTION

1. Field of the invention

The present invention relates to a mouse and pad assembly, more particularly one, of which the mouse is connected to and movable relative to the pad, and which can be maneuvered with ease and without possibility of causing carpal tunnel syndrome.

2. Brief Description of the Prior Art

Referring to FIG. 8, an optical mouse 10 includes buttons 101 on an upper side thereof, and an optical sensor device 102 on a lower side for sensing movement of the mouse in relation to a mouse pad 30. And, referring to FIG. 9, a conventional ball mouse includes buttons 201 on an upper side, and a ball-equipped sensor device 202 on a lower side for sensing movement of the mouse in relation to a mouse pad 30.

When the mice 10, 20 are moved on a plain surface, the sensor devices 102, 202 will sense movement of the mice in relation to the plain surface, and the computers connected thereto will make the cursors on the monitors move accordingly. However, optical mice and conventional ball mice have disadvantages as followings:

1. A large enough area of surface has to be provided for allowing the mice to be moved around thereon.

2. The mice can't be smoothly maneuvered where there is no plain surface or a mouse pad.

3. The sensor devices of the mice would fail to function properly if the surface are dirty, on which the mice are being maneuvered.

4. To use the mice, the users have to keep on holding the mice with the wrists in a fixed position. Consequently, the users are prone to have carpal tunnel syndrome.

The inventor of the present invention is a rehabilitation and physiatry doctor who also finds in his practice that using a computer mouse in an improper position is the major reason for paralyzed and immobile wrists.

### SUMMARY OF THE INVENTION

It is a main object of the present invention to provide a mouse and pad assembly to overcome the above disadvantages.

The mouse and pad assembly of the invention includes a pad member, and a mouse member, which is arranged above and connected to the pad member in such a way as to be angularly and linearly displaceable relative to the pad member. The mouse member has several buttons on an upper side thereof, and it has a sensor device facing the pad member for sensing movement of the mouse member relative to the pad member.

### BRIEF DESCRIPTION OF THE DRAWINGS

The present invention will be better understood by referring to the accompanying drawings, wherein:

FIG. 1 is an exploded perspective view of the first embodiment of a mouse and pad assembly according to the present invention,

FIG. 2 is a vertical section of the first embodiment of the invention,

FIG. 3 is an exploded perspective view of the second embodiment of a mouse and pad assembly according to the present invention,

FIG. 4 is a vertical section of the second embodiment,

FIG. 5 is a vertical section of the third embodiment of a mouse and pad assembly in the present invention,

FIG. 6 is a view showing a way to use the present invention,

FIG. 7 is a view showing another way to use the present invention,

FIG. 8 is a side view of the optical mouse in Background, and

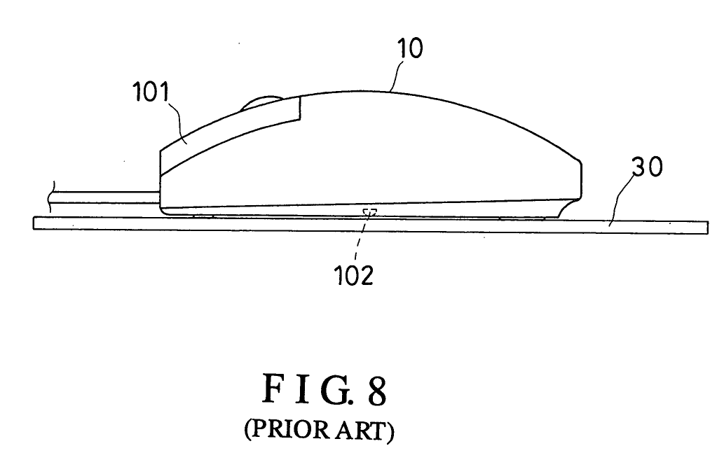

FIG. 9 is a side view of the ball mouse described in Background.

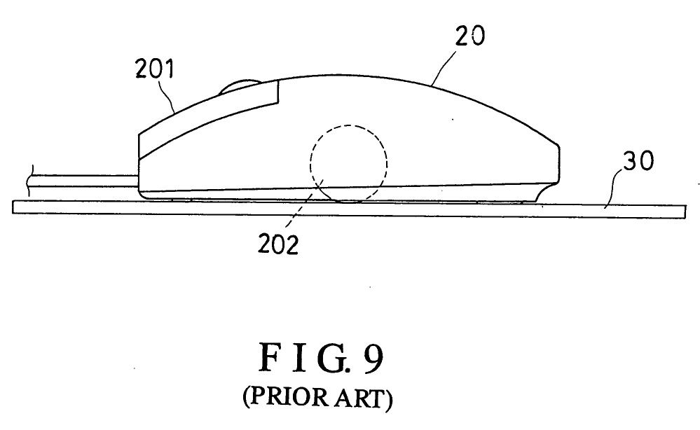

### DETAILED DESCRIPTION OF THE PREFERRED EMBODIMENTS

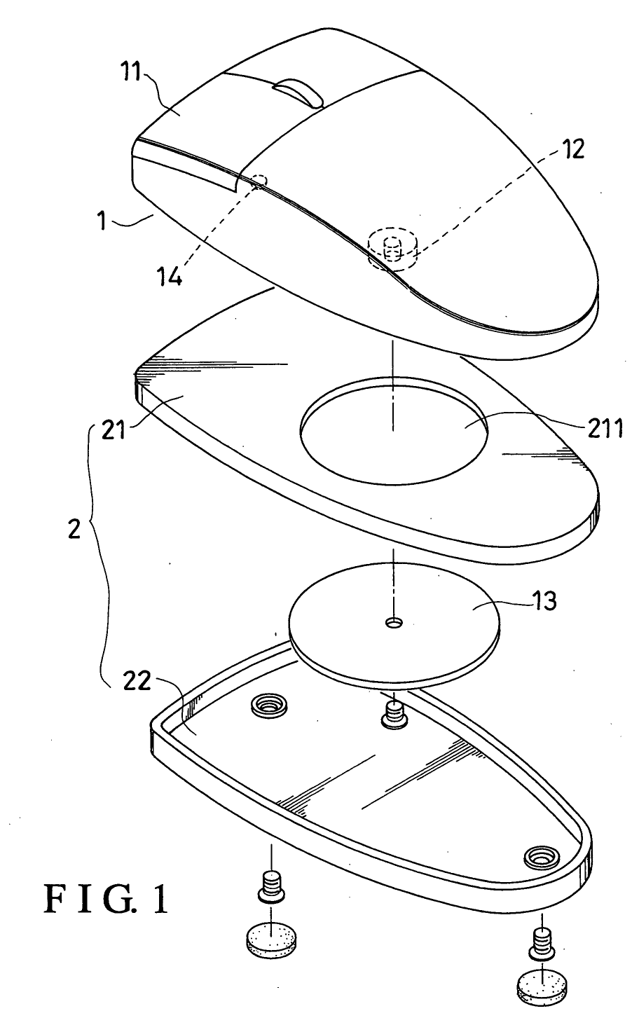

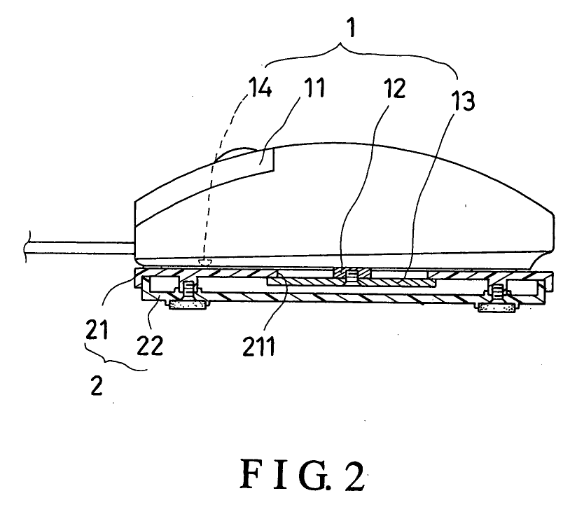

Referring to FIGS. 1 and 2, a first embodiment of a mouse and pad assembly includes a mouse member 1, and a pad member 2.

The mouse member 1 includes buttons 11 on an upper side, a cylindrical protrusion 12 on a lower side thereof, a detaining element 13, and a sensor device 14 secured on the lower side for sensing movement of the mouse member 1 relative to the pad member 2; the sensor device 14 can be an optical one or a ball-equipped one.

The pad member 2 includes an upper part 21, and a lower part 22. The upper part 21 has a round hole 211 whose diameter is smaller than that of the detaining element 13, and it is positioned on top of and securely connected to the lower part 22.

Furthermore, the detaining element 13 is movably positioned between the upper and the lower parts 21 and 22 of the pad member 2, and securely connected to the cylindrical protrusion 12; thus, the mouse member 1 can be linearly and angularly displaced relative to the pad member 1, but it can't be separated from the pad member 1. And, the sensor device 14 is arranged at such a position that it will always face those portions of the upper part 21 that are around the round hole 211 while the mouse member 1 is being moved relative to the pad member 2.

To use the present mouse and pad assembly, one can hold it being positioned on a desk or other desired planes, and move the mouse member 1 relative to the pad member 2. Still, the mouse and pad assembly can be connected to a computer or used as a wireless one; thus, the sensor device 14 will sense change of position of the mouse member 1 in relation to the upper part 21 of the pad member 2, and the computer will make the cursor on the monitor to move accordingly.

In addition, to move the cursor, the user can hold the pad member 2 with one hand, and move the mouse member 1 relative to the pad member 2 with the other hand instead, without the need for another mouse pad.

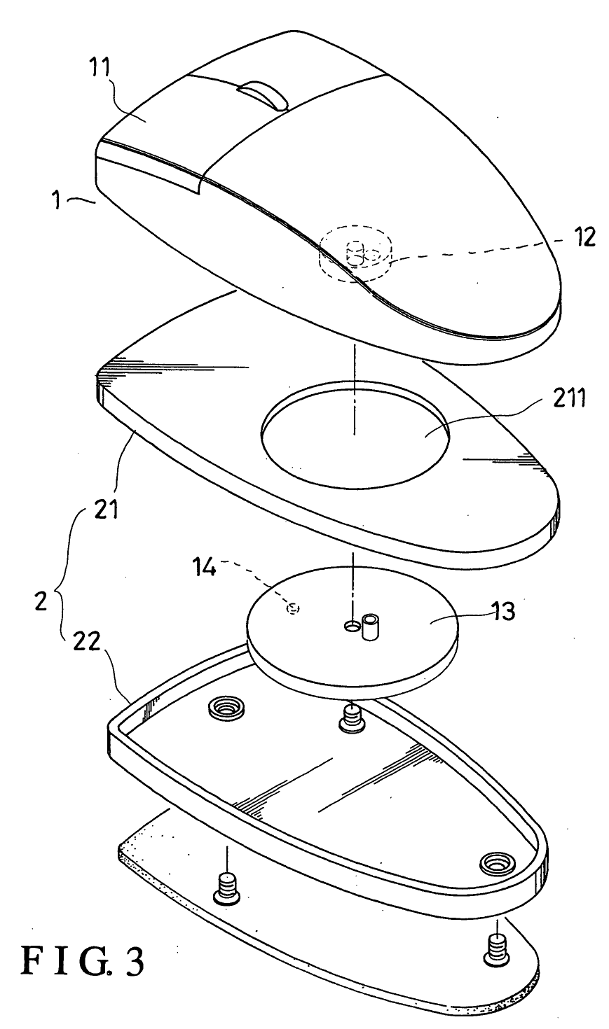

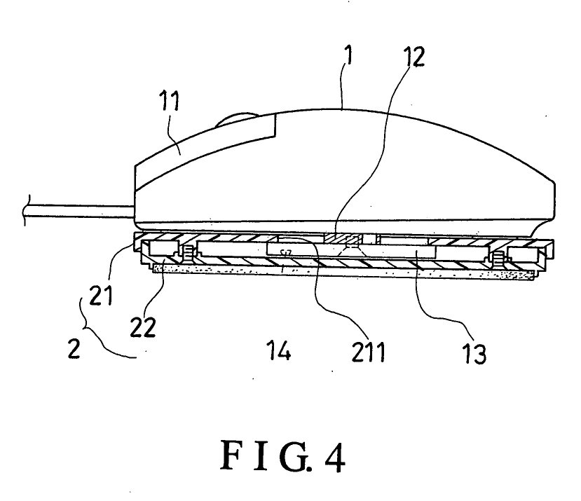

Referring to FIGS. 3 and 4, a second embodiment of a mouse and pad assembly includes a mouse member 1, and a pad member 2.

The mouse member 1 includes buttons 11 on an upper side, a cylindrical protrusion 12 on a lower side thereof, a detaining element 13, and a sensor device 14 secured on a lower side of the detaining element 13 for sensing movement of the mouse member 1 relative to the pad member 2; the sensor device 14 is equipped with an optical sensing unit.

The pad member 2 includes an upper part 21, and a lower part 22. The upper part 21 has a round hole 211 whose diameter is smaller than that of the detaining element 13, and it is positioned on top of and securely connected to the lower part 22.

Furthermore, the detaining element 13 is movably positioned between the upper and the lower parts 21 and 22 of the pad member 2, and securely connected to the cylindrical protrusion 12; thus, the mouse member 1 can be moved to change in position and orientation in relation to the pad member 1, but it can't be separated from the pad member 1. To use the second embodiment, one can hold it being positioned on a desk or other desired planes, and move the mouse member 1 relative to the pad member 2. Still, the mouse and pad assembly can be connected to a computer or used as a wireless one; thus, the sensor device 14 will sense change of position of the mouse member 1 in relation to the lower part 22 of the pad member 2, and the computer will make the cursor on the monitor to move accordingly.

In addition, to move the cursor, the user can hold the pad member 2 with one hand, and move the mouse member 1 relative to the pad member 2 with the other hand instead, without the need for another mouse pad.

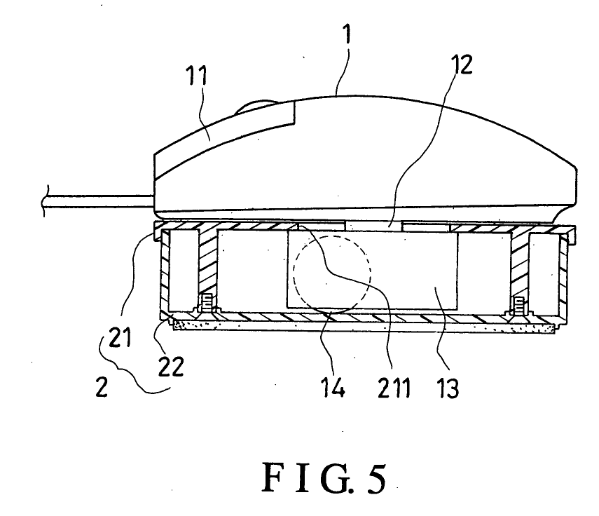

Referring to FIG. 5, a third embodiment of a mouse and pad assembly is provided, which basically has the same structure as the second one, but sensor device 14 of the third embodiment has a ball-equipped sensing unit instead of the optical sensing unit.

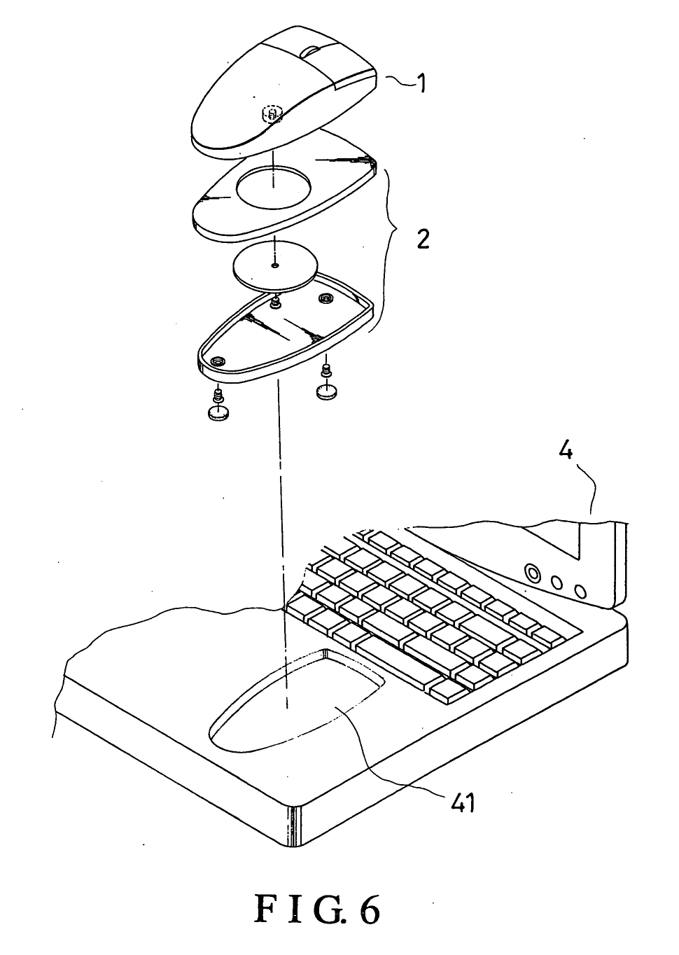

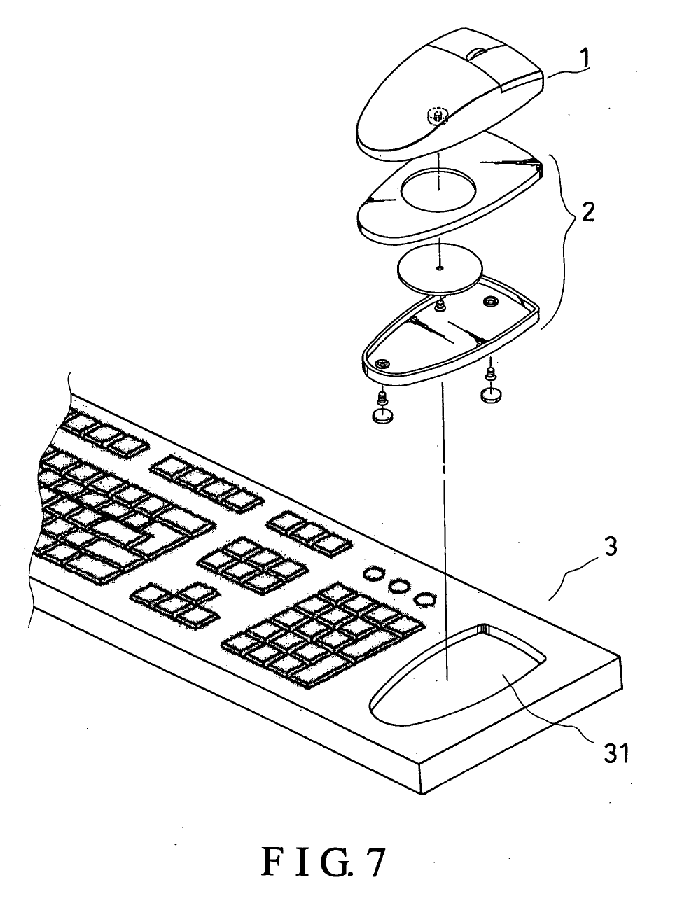

Referring to FIG. 6, a lap top computer 4 is formed with a holding recess 41 thereon, and the present invention is fitted in the holding recess 41 at the lower part 22 of the pad member 2 for the user to maneuver. And, referring to FIG. 7, a keyboard 3 is formed with a holding recess 31 thereon, and the present invention is fitted in the holding recess 31 at the lower part 22 of the pad member 2 for the user to maneuver.

From the above description, it can be easily understood that the present mouse and pad assembly has advantages as followings:

1. The assembly can be used without a mouse pad, and it even can be smoothly maneuvered on an uneven surface.

2. The assembly can be maneuvered on any place, providing that it is steadily supported.

3. The sensor device of the mouse member is held in the pad member therefore it is impossible for dirt to pass onto the sensor device to make the same fail to function properly.

4. One can use the mouse and pad assembly in a more comfortable posture, such as positioning it on a desktop or laptop, or controlling it with his hands, so that it is not limited to be used together with a mouse pad. Accordingly, the user can alternate one of the above-mentioned using approaches which can make him feel more comfortable to change operational postures and positions thereof so as to avoid carpal tunnel syndrome caused by long-term and improper usage thereof.

What is claimed is:

1. A mouse and pad assembly, comprising
a pad member; and
a mouse member arranged on top of and connected to the pad member in such a way as to be angularly and linearly displaceable relative to the pad member; the mouse member having a plurality of buttons on an upper side; the mouse member having a sensor device facing the pad member for sensing movement of the mouse member relative to the pad member.

2. The mouse and pad assembly as claimed in claim 1, wherein the sensor device of the mouse member is of an optical type.

3. The mouse and pad assembly as claimed in claim 1, wherein the sensor device of the mouse member is of a ball-equipped type.

4. The mouse and pad assembly as claimed in claim 1, wherein the sensor device is arranged on a lower side of the mouse member to face the pad member.

5. The mouse and pad assembly as claimed in claim 1, wherein the pad member includes an upper part, and a lower part securely disposed under the upper part, which upper part has a round hole, while the mouse member has a cylindrical protrusion on a lower side, and a detaining element having a greater diameter than the round hole; the cylindrical protrusion being passed through the round hole; the detaining element being movably held between the upper and the lower parts of the pad member and connected to the cylindrical protrusion.

6. The mouse and pad assembly as claimed in claim 5, wherein the sensor device is arranged on a lower side of the detaining element to face the lower part of the pad member, thus capable of sensing movement of the mouse member relative to the pad member.
